(19) United States
(12) Patent Application Publication
(10) Pub. No.: US 2017/0083973 A1
(43) Pub. Date: Mar. 23, 2017

(54) ASSIGNING BUSINESS CREDIT SCORES USING PEER-TO-PEER INPUTS ON AN OPEN ONLINE BUSINESS SOCIAL NETWORK

(71) Applicants: J. Christopher Robbins, Evergreen, CO (US); Anatoly Reynberg, West Hartford, CT (US)

(72) Inventors: J. Christopher Robbins, Evergreen, CO (US); Anatoly Reynberg, West Hartford, CT (US)

(21) Appl. No.: 15/250,537

(22) Filed: Aug. 29, 2016

Related U.S. Application Data
(60) Provisional application No. 62/210,687, filed on Aug. 27, 2015.

(51) Int. Cl. G06Q 40/02

(52) U.S. Cl. CPC G06Q 40/025

(57) ABSTRACT

A computerized open network business rating process is disclosed enabling small businesses to receive an accurate creditworthiness rating. The process is operated within a computerized processor. The process includes actively polling a plurality of peer businesses related to a subject business to monitor inputs from the plurality of businesses. The plurality of peer businesses each provide one of a good or service to the subject business. The inputs include information related to a creditworthiness of the subject business. The process further includes compiling a creditworthiness score based upon the monitored inputs and generating a report displaying the creditworthiness score for the subject company.

### CROSS REFERENCE TO RELATED APPLICATIONS

This disclosure claims the benefit of U.S. Provisional Application No. 62/210,687 filed on Aug. 27, 2015 which is hereby incorporated by reference.

### TECHNICAL FIELD

This disclosure is related to a computerized system and method to assign business credit and also vendor worthiness scores and ratings for companies using peer-to-peer inputs on an open online business social network, particularly to request inputs, monitor and compile inputs, and to publish ratings of the subject business based upon the compiled inputs. This system is an alternative to a traditional business credit bureau.

### BACKGROUND

The statements in this section merely provide background information related to the present disclosure. Accordingly, such statements are not intended to constitute an admission of prior art.

Business credit bureaus are known in the art. Known companies employ top-down models, evaluating factors such as pay experiences, debt, demographics, and data-science derived algorithmic methods to produce a credit score for a person or a company. These systems are often ineffective, however, at assigning an accurate business credit score to a small business. Most of the data relied upon by these systems is provided by a small number of large companies who report pay experience data into the credit bureaus. If a small firm is not transacting business with one of the large firms reporting pay experience data, the business credit bureau will often have insufficient data to assign a meaningful business credit score.

Customer review websites are known, where consumers can rate a product or service, provide reviews of the product or service.

### SUMMARY

A computerized open network business rating process is disclosed enabling small businesses to receive an accurate creditworthiness rating. The process is operated within a computerized processor. The process includes actively polling a plurality of peer businesses related to a subject business to monitor inputs from the plurality of businesses. The plurality of peer businesses each provide one of a good or service to the subject business. The inputs include information related to a creditworthiness of the subject business. The process further includes compiling a creditworthiness score based upon the monitored inputs and generating a report displaying the creditworthiness score for the subject company.

### BRIEF DESCRIPTION OF THE DRAWINGS

One or more embodiments will now be described, by way of example, with reference to the accompanying drawings, in which:

FIG. 1 illustrates a flowchart demonstrating an exemplary embodiment of a open network business rating process, in accordance with the present disclosure;

FIG. 2 schematically illustrates an exemplary server configured to operated the process of FIG. 1, in accordance with the present disclosure;

FIG. 3 illustrates an exemplary display screen generated to provide data on a subject company rated by the process of FIG. 1, in accordance with the present disclosure;

FIG. 4 illustrates an exemplary display screen generated to provide a company that just joined the network an opportunity to connect to other peer companies according to the process of FIG. 1, in accordance with the present disclosure;

FIG. 5 illustrates an exemplary display screen generated to enable a member company to provide creditworthiness information for a peer company according to the process of FIG. 1, in accordance with the present disclosure;

FIG. 6 schematically illustrates exemplary connections that can be established in a peer-to-peer network; and

FIG. 7 illustrates an exemplary display screen generated to enable a member company to provide vendorworthiness information for a peer company according to the process of FIG. 1, in accordance with the present disclosure.

### DETAILED DESCRIPTION

A process for gathering and compiling data for and from a plurality of companies in a database and providing ratings for the companies based upon the compiled data is provided. Peer companies can be defined as businesses doing business with each other. A supplier to a company provides a good or service to the company, and the company pays the supplier. A customer to a company buys a good or service from the company and pays the company. These peer companies develop relationships, some good, some bad. These relationships can be influenced by a number of factors, including interpersonal communications, timeliness of delivery of the good or service, timeliness of the payment due in return for the good or service, timeliness of refunds, quality of the good or service, etc.

Existing credit rating services use regimented criteria to compile credit scores. Payment histories can be provided by large banks, credit issuing agencies, large manufacturers with credit departments, etc. However, most small companies are not set up to provide payment histories for customer peers. If a small store is slow to pay a wholesaler, the wholesaler can complain or refuse future business from that store, but the credit rating of the store is not affected.

A supplier/vendor considering sending a product to a potential customer is concerned with the creditworthiness of the customer. Will my company get paid in a timely fashion after we send a shipment of goods to that customer? A computerized process is disclosed, creating and using a peer-to-peer network to identify supplier-customer relationships, actively poll member companies of the network regarding the creditworthiness of peer companies, calculate a creditworthiness of the member companies, and report credit scores of the member companies based upon the creditworthiness. In a similar or parallel process, such a peer-to-peer network and collected results of active polling can be used to calculate and report a vendorworthiness score for a particular supplier, that score telling potential customers to that company how it is to do business with that company. Vendorworthiness can include measures of the quality of goods sent, a rating of service provided by that supplier, a timeliness of refund payments, percentage of on-time delivery of a product, etc.

Actively polling members of the peer-to-peer network is distinct from simply gathering publically available information about a company. For instance, there are websites that permit users to list opinions about goods or services. However, these opinions can be misleading or manipulated. For instance, a company receiving bad reviews for a good or service can flood the review system with fake or intentionally glowing reviews to counteract the effect of the bad reviews. The peer-to-peer reviews of the present disclosure are certified by managers of the registered companies. This registration and certification process makes the results more reliable. Further, reviews from the consuming public are not necessarily useful for one company trying to decide whether to extend credit to another company. A published opinion that 82 out of 100 users like the new rubber soles from boot company A does not tell a leather supplier whether boot company A pays its bills on time. Further, wherein inputs for the present disclosure include input directly from financial software of both companies on either side of a purchase/sales transaction, the numbers are objective and tend to filter out a supplier only saying nice things about a customer company because they do not want to lose the business of the customer company. The billing dates and the payment dates are able to be firmly established and analyzed.

In one embodiment, the process can include electronic access to financial software of each of the member companies. Records regarding payment due dates and actual payment dates can be retrieved. Records regarding purchase orders and actual delivery dates can be retrieved. Records regarding complaints and recorded resolutions of complaints can be retrieved. If both companies are members of the peer-to-peer network, the financial records of both companies can be compared, and, for example, if a payment is shown to have been received late at a supplier but was shown to have been paid on time at the corresponding customer, the discrepancy between these records can be flagged. Such a discrepancy flag can be used in a number of ways. The negative impact of the late payment can be reduced in a creditworthiness score calculation. Both companies can be electronically prompted to provide support for the dates in each company's records. Staff of the company running the peer-to-peer network can be prompted to call the two companies and investigate the discrepancy.

Active polling of companies in a peer-to-peer network can be a regimented process, for example, with a weekly questionnaire being delivered electronically to the computer of a purchasing or sales manager in a company. The questionnaire can include records of all payments made by customers to the company and ask the manager to certify that late payments were in fact late. The questionnaire can provide a scalar set of options for the manager to rate peer companies (e.g., please rate these four companies for creditworthiness, on a one to five star basis.) Active polling can include presenting an option to a manager, for example, asking the manager, “Are there any customers that you would like to provide a creditworthiness score for today?” In addition to active polling, the process can include an option for the managers to seek out an ability to provide a rating for a company. For example, a manager can use a desktop icon to initiate a survey, permitting the manager to rate some or all peer companies.

An exemplary sequence of process operations is provided. A potential user receives an email from a supplier/vendor notifying the user of a published pay experience and inviting the user to view his company's peer-to-peer profile. The potential user clicks on a button in the email and lands on a redacted company profile for his company including a welcome message. The potential user sees the redacted version of the company profile along with an option to claim and register his company within the peer-to-peer network. The user completes the registration and gains access to periodic updates of the company's creditworthiness score. The user is provided an option to create a supply chain, designating other peer companies that the company does business with (both supplier/vendors and customers.) Invitations to join the peer-to-peer network are sent to newly identified peer companies. Each company in the peer-to-peer network is periodically actively polled regarding experiences interacting and doing business with the other peer companies in the network. Polls can include only a current rating or can ask for a historical rating for each of several previous months for a particular company.

In addition to a creditworthiness or vendorworthiness score, a summary of a company that can be viewed by peer companies can include information, for example, through analysis of the company's financial software, such as a risk summary of how likely it is that the subject company will not pay on time in the next twelve months and how likely it is that the company will experience financial stress in the next twelve months. Such information can be determined by statistics such as declining sales, an increasing level of rejected shipments, declining employee count, etc. which are available through access to financial records of a company. The summary can include a debt to income ratio for each of a past few years. The summary can include a summary breakdown of how many bad, average, and good ratings the company received from other peer companies.

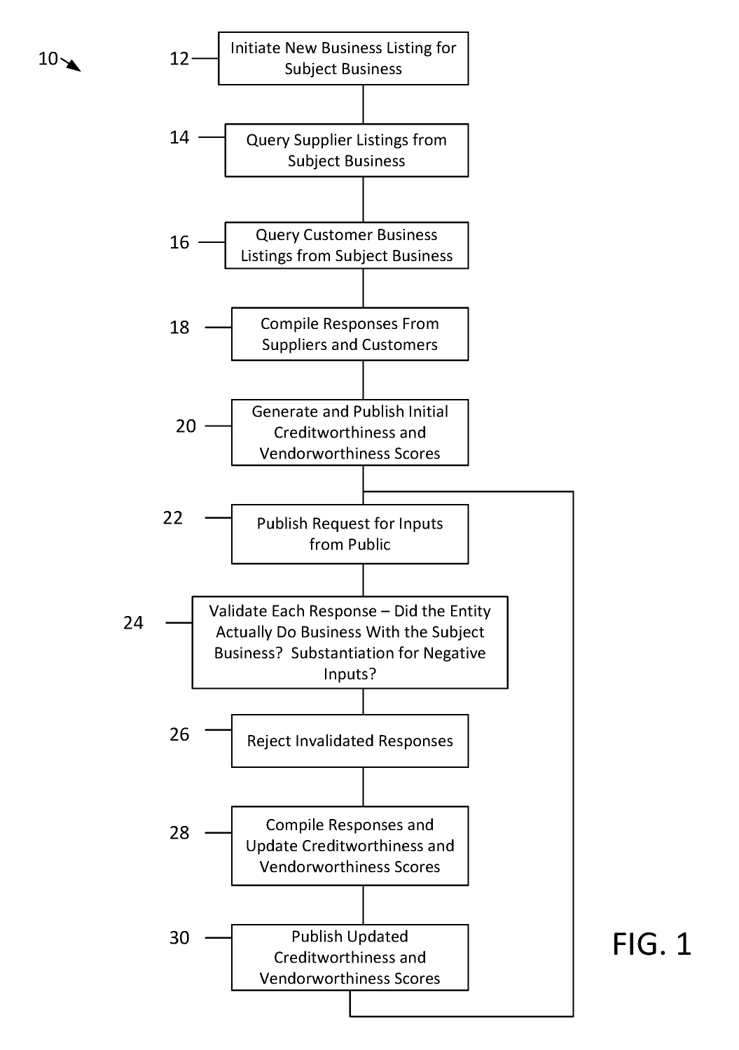

Referring now to the drawings, wherein the showings are for the purpose of illustrating certain exemplary embodiments only and not for the purpose of limiting the same, FIG. 1 illustrates a flowchart demonstrating an exemplary embodiment of a open network business rating process. Computerized process 10 describes how a listing for a subject business is initiated and maintained and starts at step 12, where a new business listing is generated. At step 14, the subject business is asked to supply a list of suppliers that do business with the subject business. At step 16, the subject business is asked to supply a list of businesses to which the subject business sells. At step 18, the process compiles the responses received from the inquiries of steps 14 and 16. While this compilation is shown as an event, it will be understood that this compiling can be an iterative process as new replies are submitted. At step 20, the process generates and publishes initial creditworthiness and vendorworthiness scores for the subject company. These scores can be stored in a database and be made available through a website, a cell phone application, printed in a book or upon a company specific advertisement, or other similar means of publishing information. Steps 22 through 30 illustrate maintenance and updating of the published scores based upon public feedback. In step 22, a public request for inputs regarding the creditworthiness and vendorworthiness of the subject company is published. In step 24, an optional validation step is used to judge inputs received from the public request. In one embodiment, the person or company providing the input simply has to provide identifying information and make a statement that business was in fact conducted with the subject company. In another embodiment, the company running the database or an independent watchdog company can certify or reject a response to the public input, for example, by validating some or all of the responses with a call or verified correspondence with the inputting company. In the illustrated example, the company operating the database can determine whether the inputting company actually did business with the subject company and can request substantiation for a negative input. In step 26, the process can reject any invalidated responses to the public inquiry. In step 28, the process compiles responses and updates creditworthiness and vendorworthiness scores. In step 30, the process publishes updates to the creditworthiness and vendorworthiness scores. The process then reiterates to step 22, where new public inputs can be received and the updated process can be rerun.

Process 10 is provided as an example of how an open network business rating process can be operated. A number of alternatives are envisioned. For example, a process could only rate one of the creditworthiness and the vendorworthiness of a subject company. A process could omit steps 24 and 26, and permit any and all responses to affect the scores of a subject business. A process can provide a qualitative value of either the vendorworthiness or creditworthiness scores. For example, a number of responses can be listed. An identity of respondents and itemized scores can be provided to enable a viewer to judge how much weight should be given to each response. Each response can be scaled for effect upon the average rating of the subject company, for example, with a certified answer from a supplier company being given more weight than a un-certified or anonymous rating or with responses from larger companies being given more weight that ratings from smaller companies. In one embodiment, the process can provide comparisons of companies, for example, a purchasing manager of a company being able to compare four different suppliers at once on a same display screen. A number of alternative embodiments of the disclosed process are envisioned, and the disclosure is not intended to be limited to the particular examples provided herein.

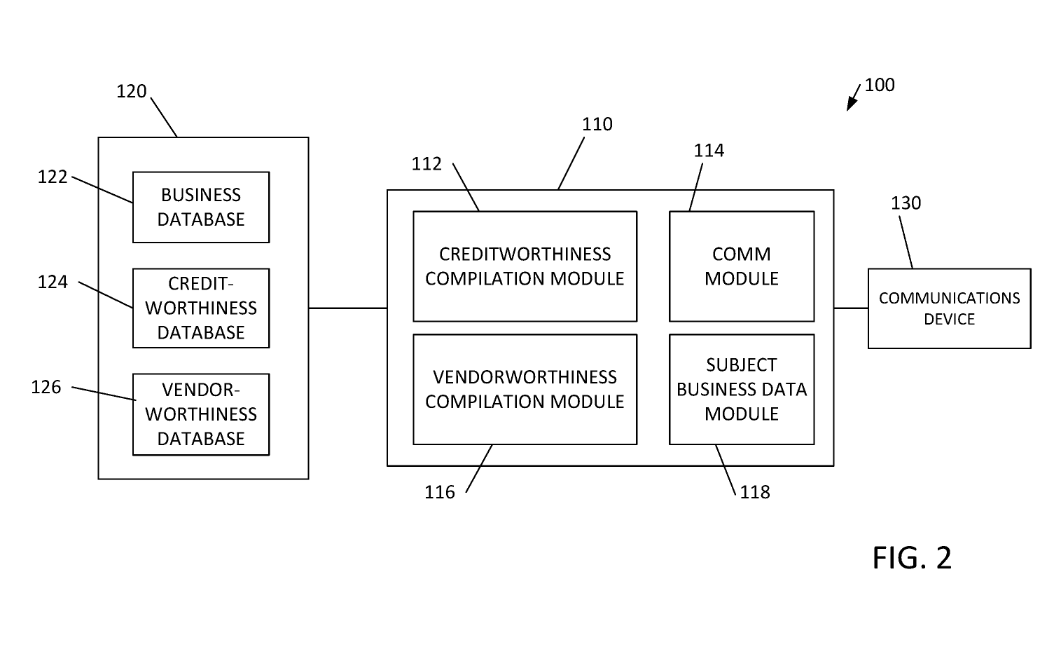

FIG. 2 schematically illustrates an exemplary server configured to operated the process of FIG. 1. Server 100 is illustrated, including processor 110, memory storage device 120, and communications device 130.

Processor device 110 includes a computerized processing device incorporating a processor, RAM memory, and durable memory storage according to server devices known in the art. Processor device 110 can include a single physical device or can include a plurality of linked physical devices. Modules operated within device 110 include programming and programmed functions that may exist on one physical device or across a plurality of physical devices. Processor device 110 can operate computerized programming to execute a process enabled by the programming, and process device 110 can be configured to accept inputs and display outputs to a person or business entity operating server 100. Processor device 110 includes modules or computerized programs configured to achieve different aspects of a process. Creditworthiness module 112 includes programming configured to receive data, compile the data, and output a creditworthiness score for a particular subject company. Vendorworthiness module 116 includes programming configured to receive data, compile the data, and output a vendorworthiness score for a particular subject company. Subject business data module 118 includes programming configured to process data for a subject business, for example, coordinating identifying data such as location data and product information for a particular company and can route or label incoming data as pertaining to a particular one company within a database of companies. Communications module 114 processes data for communication over a telecommunications or Internet communications network through communications device 130.

Memory storage device 120 includes a hard drive or other similar storage means for collecting and durably storing information related to the disclosed process. Memory storage device 120 is in communication with processing device 110 and provides and stores information as required by the programming within device 110. Business database 122 stores information about each of the businesses that are rated by the disclosed process. Creditworthiness database 124 stores information related to creditworthiness ratings collected for each business. Vendorworthiness database 126 stores information related to vendorworthiness ratings collected for each business.

Server 100 is provided as an exemplary device for operating the disclosed process. Server hardware is generally known in the art. A number of different embodiments of the server are envisioned, and the disclosure is not intended to be limited to the particular examples provided herein.

Server 100 can operate a website for receiving information and publishing data that can be accessed by any web-enabled device known in the art. In another embodiment, server 100 can be used in cooperation with a program configured to be downloaded onto a remote computer or cellular device. In another embodiment, server 100 can be configured to receive hand filled-out questionnaires about a company and receive input from the questionnaires either manually or through a scanning device. A number of interface means for persons or companies viewing from or providing information to the disclosed process are envisioned, and the disclosure is not intended to be limited to the particular embodiments provided herein.

Inputs related to a company can include inputs from individual consumers. In another embodiment, inputs to the disclosed process can be limited to corporate or group entities.

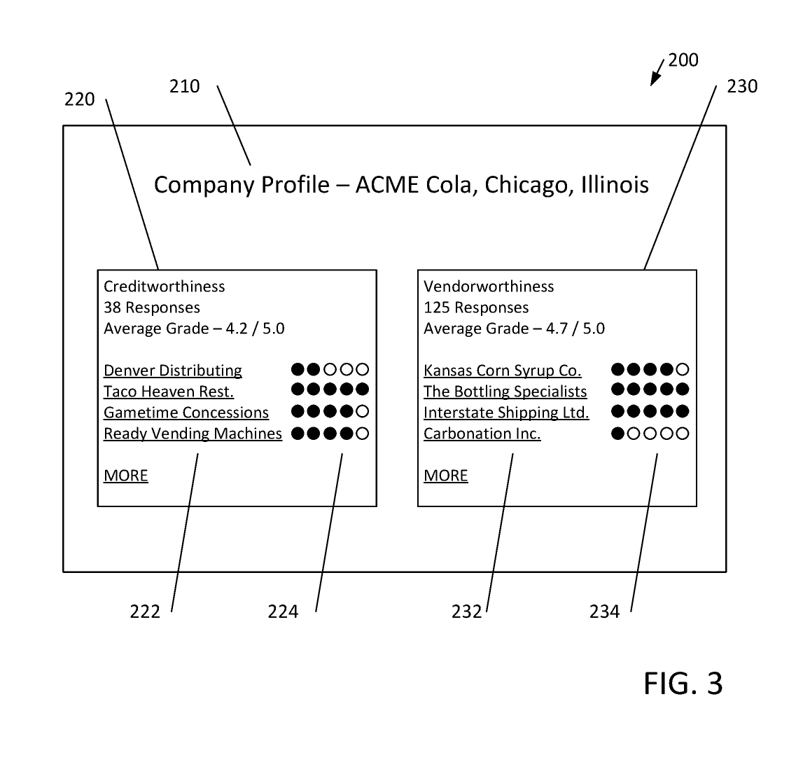

FIG. 3 illustrates an exemplary display screen generated to provide data on a subject company rated by the process of FIG. 1. Display screen 200 is illustrated including an identifying banner 210, a creditworthiness summary 220, and a vendorworthiness summary 230. Banner 210 identifies the subject company including location information so that a viewer can determine if the right company of interest has been identified. Creditworthiness summary 220 includes information related to a creditworthiness score determined by the disclosed process. Summary 220 can include itemized responses including company names 222 and graphic rating displays 224 for each responding company. A link can be provided for the viewer to be able to see more or all responses. Responses can include date stamp information, for example, enabling a view to tell how recently a response was entered. Summary 220 provides an average grade and a number of responses or inputs received for the subject company. Vendorworthiness summary 230 includes information related to a vendorworthiness score determined by the disclosed process. Summary 230 can include itemized responses including company names 232 and graphic rating displays 234 for each responding company. A link can be provided for the viewer to be able to see more or all responses. Responses can include date stamp information, for example, enabling a view to tell how recently a response was entered. Summary 230 provides an average grade and a number of responses or inputs received for the subject company.

Other displays can include displays enabling a company to initiate a listing within the database, enabling a company to respond or provide an input for a particular subject company in the database, enabling a company or person to compare multiple companies to each other, and enabling a subject company to challenge a particular response or input.

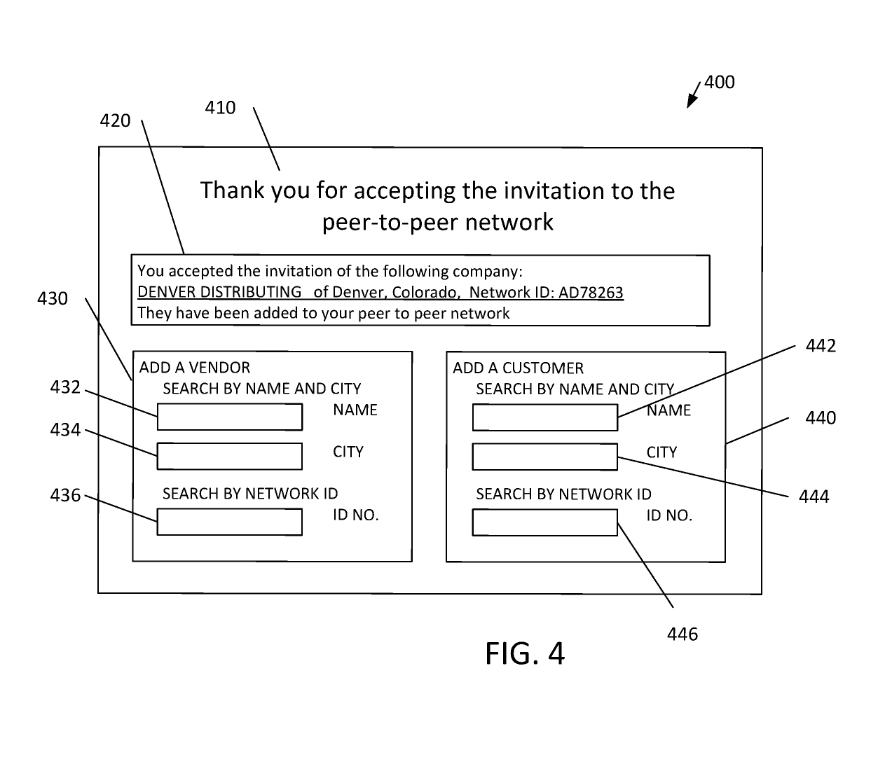

FIG. 4 illustrates an exemplary display screen generated to provide a company that just joined the network an opportunity to connect to other peer companies according to the process of FIG. 1. Display 400 is illustrated including banner message 410 thanking the user for accepting an invitation to join the peer-to-peer network. Message 420 informs the user that by accepting the invitation that was generated by another company, that company has already been set up within the network of the user's company. Block 430 enables the user to add a vendor to her company's network, either by entering the company name and city in blocks 432 and 434, respectively, or by entering a specific peer-to-peer network ID for a company, if known, for example as printed upon an invoice or purchase order. Block 440 similarly enables the user to add a customer to her company's network, either by entering the company name and city in blocks 442 and 444, respectively, or by entering a specific peer-to-peer network ID. If an entered company is already in the network, the connection can be automatically added. If an entered company is not yet in the network, an invitation can automatically be sent to the company, for example, by prompting the user to enter a manager's email address at the company to be added/invited. FIG. 4 is a non-limiting example of how companies might be added to a peer-to-peer network. Other examples could include by taking company identification information from a company's financial software, for example, by looking at companies that either paid or were paid by the subject company.

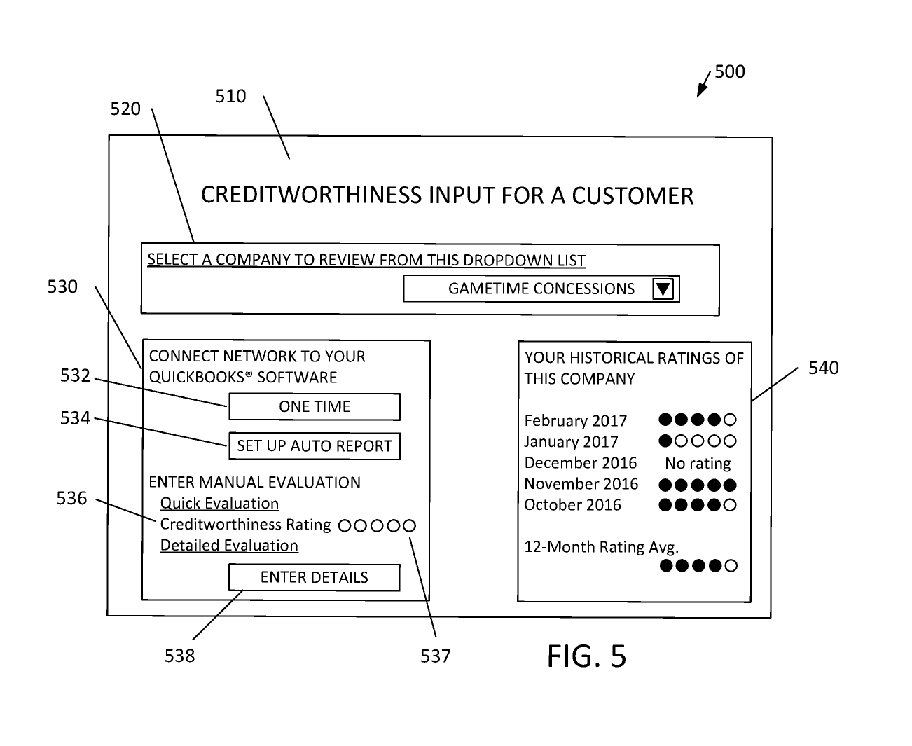

FIG. 5 illustrates an exemplary display screen generated to enable a member company to provide creditworthiness information for a peer company according to the process of FIG. 1. Display 500 is provided illustrating how a user might be able to provide input regarding a customer company's creditworthiness. Banner message 510 informs the user of the purpose of the displayed page. Block 520 enables the user to use a drop down menu to select from a plurality of customer companies registered to the user's company's network. Block 530 enables the user to enter or control inputs to be sent to the network regarding the selected customer company's creditworthiness. A message invites the user to use either buttons 532 or 534 to permit access to his company's financial software either once or as an auto report function, respectively. Hitting button 534 would bring the user to a sub-menu, for example, permitting the user to select periodic reports to be automatically sent to the network or to select periodic prompts to the user asking “Is it OK to give the peer-to-peer network access to your financial records now?” Quick evaluation inquiry 536 permits the user to enter a scalar inquiry evaluation 537, wherein the user can click upon one of the dots to quickly provide a creditworthiness evaluation on a scale of 1 out of 5 (very poor) to 5 out of 5 (very good). It will be appreciated that the magnitude of the scale is arbitrary. The scale could be as minute as a single box asking the user to simply endorse or not endorse the subject company as creditworthy, or the scale could be a rating out of 10 or 100, although such a large number would use a numerical input in place of the exemplary graphical circles. Button 538 enables the user to go to a sub-menu to provide increased details, reasoning, etc. for the evaluation. Block 540 provides a summary of the historic ratings for the selected company by the user or the user's company for reference.

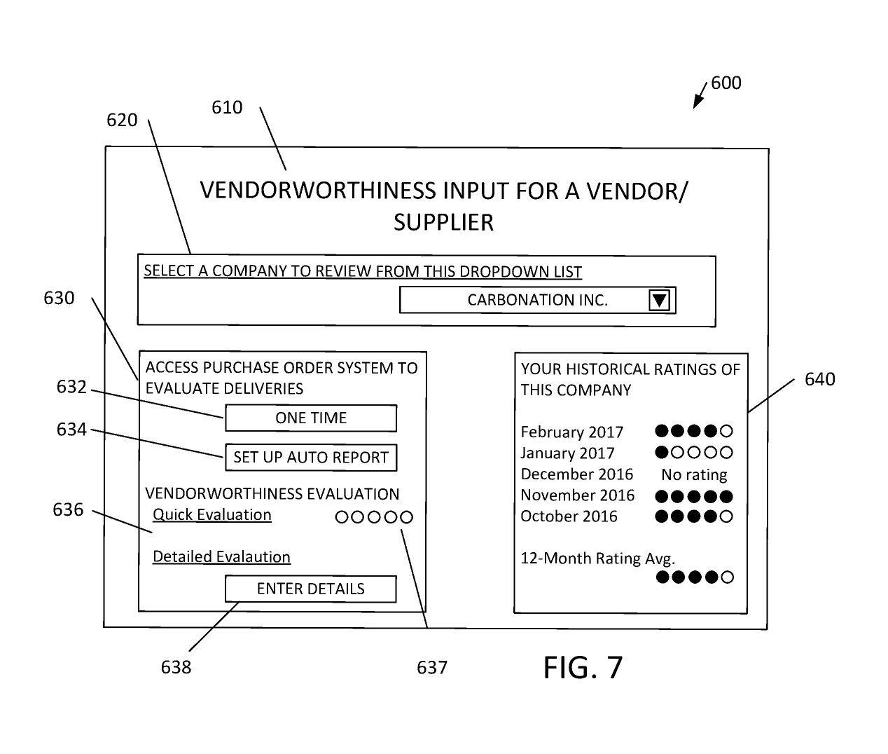

FIG. 7 illustrates an exemplary display screen generated to enable a member company to provide vendorworthiness information for a peer company according to the process of FIG. 1. Display 600 is provided illustrating how a user might be able to provide input regarding a customer company's vendorworthiness. Banner message 610 informs the user of the purpose of the displayed page. Block 620 enables the user to use a drop down menu to select from a plurality of customer companies registered to the user's company's network. Block 630 enables the user to enter or control inputs to be sent to the network regarding the selected customer company's vendorworthiness. A message invites the user to use either buttons 632 or 634 to permit access to his company's purchase order software either once or as an auto report function, respectively. The exemplary display uses a purchase order system as the system best suited to provide information regarding the performance of the vendor, such as on-time deliveries and delivery rejections. It will be appreciated that difference companies can use different reporting systems to track the performance of vendors, and the references to a purchase order software system herein is meant as a non-limiting example. Hitting button 634 would bring the user to a sub-menu, for example, permitting the user to select periodic reports to be automatically sent to the network or to select periodic prompts to the user asking “Is it OK to give the peer-to-peer network access to your purchase order records now?” Quick evaluation inquiry 636 permits the user to enter a scalar inquiry evaluation 637, wherein the user can click upon one of the dots to quickly provide a vendorworthiness evaluation on a scale of 1 out of 5 (very poor) to 5 out of 5 (very good). It will be appreciated that the magnitude of the scale is arbitrary. Button 638 is provided to permit the user to enter details regarding the evaluation. Block 640 provides a summary of the historic ratings for the selected company by the user or the user's company for reference.

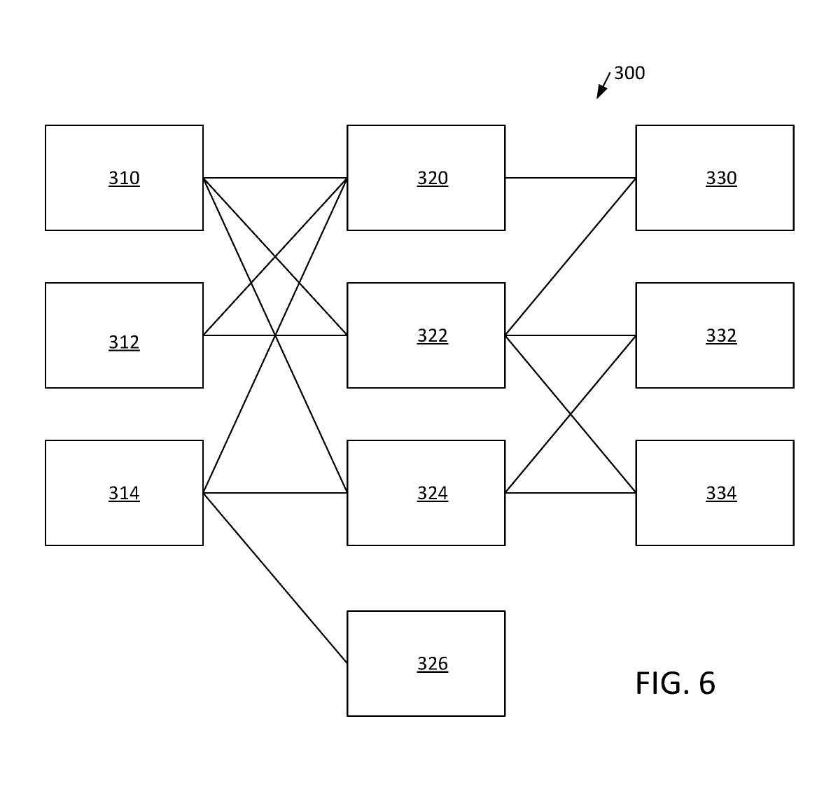

FIG. 6 schematically illustrates exemplary connections that can be established in a peer-to-peer network. Peer-to-peer network 300 is illustrated, including illustrated business transaction relationships between a plurality of member companies. Illustrated boxes include the member companies, and lines between the boxes illustrate Company 310 is illustrated selling products or services to member companies 320, 322, and 324. In return, companies 320, 322, and 324 pay company 310, and these payments can be tracked through financial software, evaluated by managers of company 310, or otherwise analyzed to provide a peer-to-peer creditworthiness of companies 320, 322, and 324. Similarly, the quality, on-time delivery, customer service, timeliness of refunds, etc. can be evaluated by companies 320, 322, and 324 to provide a vendorworthiness rating of company 310.

Company 312 is illustrated selling products or services to member companies 320 and 322. Company 314 is illustrated selling products or services to member companies 320 and 324. Company 314 also sells to company 326, which may have accepted an initial invitation to connect to the peer-to-peer network but has yet to complete the registration process. In addition to buying goods or services from companies 310, 312, and 314, member companies 320, 322, and 324 additionally sell goods or services to companies 330, 332, and 334 as illustrated by the connecting lines. In the event that company 320, which initially does not sell goods or services to company 332, establishes a business relationship with company 332, such a connection can be added to the peer-to-peer network, including all of the analysis and reviews that take place between peer companies.

Companies 330, 332, and 334 may sell directly to the consuming public which would not be included in the peer-to-peer network, although data from customer reviews, third party evaluation sites, consumer protection services, government databases (such as tracking issued patents, payment of patent maintenance fees, and patent expiration dates by a company), and other information can be incorporated as part of an overall evaluation of the member companies in the resulting output of the processes of the present application.

It will be appreciated that network 300 is exemplary and any number or permutations of peer-to-peer networks can be served by the processes of the present disclosure.

The following describes one embodiment in greater detail that the processes disclosed herein may entail. Vendorworthiness, vendorworthy, or vendor worthiness in this disclosure is in reference to the score generated by the disclosed system and its members, indicating customer satisfaction from goods or services, and customer service, provided by a vendor. Creditworthiness, creditworthy, or credit worthiness in this disclosure is in reference to the score generated by the disclosed system and its members, indicating the likelihood of customers to pay sums owed to a vendor in a timely fashion and/or to not default. Peer to peer, peer-to-peer or P2P in this disclosure refers to the ability of commercial entities to rate, evaluate, score and review each other for creditworthiness or vendorworthiness, complementing the data score provided by the disclosed systems. Pay experience or PE in this disclosure refers to a review posted by a vendor of its customer and scores how quickly that customer pays.

The purpose of the disclosed peer-to-peer credit scoring system is to create a score based on business entities reviewing each other, which compliments a data-based credit scoring system. The parameters for peer-to-peer scoring are pay experiences and past credit scores and predicative credit scores. In this manner, vendors will score the pay experiences with their clients, and clients will score the quality of services and products received by their vendors in a different feature of the disclosed system.

The peer-to-peer credit scoring system can be supplementary to a data-based credit scoring system and is open to all businesses to review each other, pending verification by the system's supervisory client services.

Aggregation of pay experience reviews and vendorworthiness reviews creates two separate scores of 1-100 and users may view a company's reputation and score in this manner, thus aiding them in making business decisions.

One example of the peer-to-peer scoring system provides the following outputs: immediate source of actual timely information, verified by the system, constantly accumulating and thus a dynamic output, strongly correlated with modeled outcome which is strictly data based, and overall weighted score, which complements the data based credit score.

The disclosed peer-to-peer credit scoring system can be a supplementary feature to a standard credit-scoring system, which is solely data based. The peer-to-peer credit scoring system relies on reviews posted by companies regarding business interactions with each other. The types of business interactions are pay experiences and vendor experiences.

The peer-to-peer credit scoring system is editable by companies and is under limited control or monitoring by system administrators. The peer-to-peer credit scoring system receives the input provided by companies about each other and weighs it against an additional data input already on the system's database.

The peer-to-peer credit scoring system processes the two data aggregations and creates an output, which is a weighted predictive business credit score.

An exemplary process flow of the disclosed system is provided. A member will enter the system's website address and will use the search function in order to search for a business entity that he/she wishes to review or submit a pay experience for. The business may be prompted to review or post a payment experience by another business, company or individual. Such an engagement will not alter the user experience flow or the input and outputs processed by the system. Based on the type of business relationship (vendor or customer) the member will submit a pay experience, which will affect the creditworthiness score, or a vendorworthiness review, which will affect that company's vendorworthiness score. The data provided by the member is weighed against data already available to the system and is processed by an algorithm. The system's algorithm will generate an output in the form of a business credit score, from 1-100.

An exemplary pay experience input by a user can be measured by three characteristics. A first is timeliness. Timeliness is defined in this disclosure as the timeliness in which the transaction has occurred. This parameter is subjectively defined by the business and not by the system as it depends on specific Service Level Agreements or contracts, which vary from company to company. For example, Business A has an agreement with Business B to pay its balance within 30 days of receiving merchandise or services provided by Business B. Business B will score the timeliness of Business A's payments.

A second is history or recency. History/recency is defined in this disclosure as the amount of time passed since the last transaction. This parameter is objectively defined by the system and is date-based. Following the example above, the system will track the reported payment intervals and will detect whether the interval span is increasing or decreasing.

A third is count. Count is defined in this document as the number of payment events or occurrences of transactions divided by type. This parameter can be included in the model as a set of counts or as a single combined pay experience score. Following the example above, the system will track and differentiate different types of payments, such as late fees, interest payments, transportation charges, tariffs and other charges not necessarily directly related to the specific products or services delivered.

A number of different evaluation processes and particular algorithmic analyses can be used in accordance with the disclosed peer-to-peer networks. An exemplary algorithmic methodology for defining the score of the pay experience can include as follows. Step 1: Cumulative Pay Experience score calculation: at any moment in time the Cumulative Pay Experience Score is calculated as sum of weighted by the recency coefficients. Numerical timeliness values of self-reported/verified and vendor reported Pay Experience occurrences over the accumulation period (1 year until changed). (Upon later consideration we may add self reported/non-verified Pay Experience here, but with some weight lesser than 1). Recency coefficients can be continuously optimized upon data accumulation.

Exemplary weights and values can be provided as follows. A recency weight for very recent transactions (<90 days, for example) can be 1.0; a recency weight for a recent transaction (90-180 days, for example) can be 0.75; a recency weight for a long ago transaction (180-365 days, for example) can be 0.5; and a recency weight for transactions outside the relevant time period (>365 days ago, for example) can be 0.0. A timeliness value for very early payments can be 4; a timeliness value for early payments can be 3; a timeliness value for on time payments can be 2; a timeliness value for late payments can be −1; and a timeliness value for very late payments can be −3. Should this data not already be in the system's database, the system will automatically calculate the cumulative pay experience score based on the above methodology. This calculation can and will occur upon every request for company information, referred to in this document as “firmographic” information. The purpose of this recalculation is to constantly update the database with a current cumulative pay experience score, which is subject to new experiences and changes at any time.

Step 2: Pay experience score (PES) calibration: the system can use the following exemplary calibration form:

PES=−30 if S<=−30S if −30<S<=20 20 if S>20 [1]

Step 3: The system will process the data results from the above calculations and algorithmically calculate a “Predictor” value, or score. The system will combine the pay experience score with the Altman Type-Z score in the logistic overall logistic regression models, thus creating a predictive score.

This algorithm can be constantly balanced and optimized by data and predictors by public sources as well as macroeconomic indicators combined with the personal credit characteristics of the business owner or manager.

Step 4: An output is generated in the form of a credit score of 1-100. This score is dynamic and can be changed at any time should the input data change.

An exemplary output of the system's scoring process is provided. The overall score is a linear combination of the model score (MS), financial score (FS) and PES. The following equations are provided for determining the overall score.

if c1, c2, c3 are corresponding coefficients such as c1+c2+c3=1 then Score=100*(c1*NormalizedMS+c2*NormalizedFS+c3*NormalizedPES) [2]

Normalized MS=(MS−min MS)/(max MS−min MS) [3]

Normalized FS=(FS−min FS)/(max FS−min FS) [4]

Normalized MS=(PES−min PES)/(max PES−min PES) [5]

MS values include a minimum of 2 and a maximum of 100. FS values include a minimum of −20 and a maximum of 10. PES values include a minimum of −30 and a maximum of 20.

In Equations 2-5, wherein the sum of c1, c2, and c3 values equal 1, when all three component values are known, exemplary values of the components can include c1 of 0.4; c2 of 0.3; and c3 of 0.3. When a PE value is not available, exemplary values of the components can include c1 of 0.6; c2 of 0.4; and c3 of 0.0. When a FS value is not available, exemplary values of the components can include c1 of 0.6; c2 of 0.0; and c3 of 0.4. When no model predictors are available, the components can include When a PE value is not available, exemplary values of the components can include c1 of 0.0; c2 of 0.5; and c3 of 0.5. These values would be adjusted as additional data became available. Equations 1-5 and the associated values are exemplary, any number of alternative algorithms can be employed with the disclosed peer-to peer networks, and the disclosure is not intended to be limited to the examples provided herein.

The above processes can be operated on a server device to enable operation of a creditworthiness/vendorworthiness service upon an Internet website, with ratings of various companies developed from peer-to-peer networks either publically available, available to other companies within the network, or available as a premium/subscriber service.

The disclosure has described certain preferred embodiments and modifications of those embodiments. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. A computerized open network business rating process, comprising:
within a computerized processor:
actively polling a plurality of peer businesses related to a subject business to monitor inputs from the plurality of businesses, wherein the plurality of peer businesses each provide one of a good or service to the subject business, wherein the inputs comprise information related to a creditworthiness of the subject business;
compiling a creditworthiness score based upon the monitored inputs; and
generating a report displaying the creditworthiness score for the subject company.

2. The computerized process of claim 1, wherein the information related to the creditworthiness comprises a pay history of the subject business, the pay history comprising timeliness of payments by the subject company.

3. The computerized process of claim 2, wherein the pay history further comprises a recency of the payments by the subject company.

4. The computerized process of claim 2, wherein monitoring the inputs comprises accessing financial software at the plurality of businesses.

5. The computerized process of claim 1, wherein the information related to the creditworthiness comprises a scalar inquiry evaluation by the plurality of businesses.

6. The computerized process of claim 1, further comprising:
actively polling a second plurality of peer businesses related to the subject business to monitor inputs from the second plurality of businesses, wherein the peer businesses each purchase one of a good or service from the subject business, wherein the inputs comprise information related to a vendorworthiness of the subject business;
compiling a vendorworthiness score based upon the monitored inputs; and
generating a report displaying the vendorworthiness score for the subject company.

7. The computerized process of claim 1, further comprising:
monitoring inputs from the subject company defining a new peer company with which the subject company does business; and
actively polling a one of the subject company and the new peer company to get a pay history for a second of the subject company and the new peer company.

8. The computerized process of claim 1, further comprising:
actively polling the subject company for new peer companies with which the subject company does business; and
creating a peer-to-peer network for the subject company based upon the polling the subject company for new peer companies.

9. The computerized process of claim 1, further comprising:
accessing financial software of the subject company to identify new peer companies with which the subject company does business; and
creating a peer-to-peer network for the subject company based upon the identified new peer companies.

10. The computerized process of claim 1, further comprising monitoring public comments about the creditworthiness of the subject company; and
wherein compiling the creditworthiness score is further based upon the public comments.

11. A system to operate a computerized open network business rating process, comprising:
a server device comprising a computerized processor with programming configured to:
actively poll a plurality of peer businesses related to a subject business to monitor inputs from the plurality of businesses, wherein the plurality of peer businesses each provide one of a good or service to the subject business, wherein the inputs comprise information related to a creditworthiness of the subject business;
compile a creditworthiness score based upon the monitored inputs; and
provide within an Internet website a report displaying the creditworthiness score for the subject company.

12. The system of claim 11, with programming further configured to:
actively poll a second plurality of peer businesses related to the subject business to monitor inputs from the second plurality of businesses, wherein the peer businesses each purchase one of a good or service from the subject business, wherein the inputs comprise information related to a vendorworthiness of the subject business;
compile a vendorworthiness score based upon the monitored inputs; and
generate a report displaying the vendorworthiness score for the subject company.

13. The system of claim 11, with programming further configured to:
actively poll the subject company for new peer companies with which the subject company does business; and
create a peer-to-peer network for the subject company based upon the polling the subject company for new peer companies.

14. A computerized open network business rating process, comprising:
within a computerized processor:
within a computerized processor:
actively polling a plurality of peer businesses related to a subject business to monitor inputs from the plurality of businesses, wherein the plurality of peer businesses each purchase one of a good or service from the subject business, wherein the inputs comprise information related to a vendorworthiness of the subject business;
compiling a vendorworthiness score based upon the monitored inputs; and
generating a report displaying the vendorworthiness score for the subject company.
